(19) United States
(12) Patent Application Publication
(10) Pub. No.: US 2023/0168383 A1
(43) Pub. Date: Jun. 1, 2023

(54) NAVIGATION MODULE

(71) Applicant: Guidance Automation Limited, Leicester (GB)

(72) Inventor: Paul Rivers, Leicester (GB)

(21) Appl. No.: 17/982,934

(22) Filed: Nov. 8, 2022

(30) Foreign Application Priority Data
Nov. 26, 2021 (GB) 2117086.5

(51) Int. Cl. G01S 17/931; G01S 7/481

(52) U.S. Cl. CPC G01S 17/931; G01S 7/4815; G01S 7/4816

(57) ABSTRACT

A navigation module determines the position of an automated guided vehicle. The navigation module includes a light source for emitting light; a receiver for receiving light emitted from the light source; and a processor operatively connected to the light source and to the receiver. The navigation module also includes a first mode of operation in which light is emitted continuously from the light source and the processor processes light received by the receiver to identify a predetermined reflective target; and a second mode of operation in which light is pulsed from the light source and the processor processes light received by the receiver to determine a distance to the predetermined reflective target.

### CROSS-REFERENCE TO RELATED APPLICATIONS

This application claims priority pursuant to 35 U.S.C. 119(a) to United Kingdom Patent Application No. 2117086.5 filed Nov. 26, 2021, which application is incorporated herein by reference in its entirety.

### BACKGROUND

This invention relates generally to a navigation module. More specifically, although not exclusively, this invention relates to an improved navigation module for an automated guided vehicle. This invention also relates to an automated guided vehicle including a navigation module, an automated guided vehicle navigation system and a method of determining the position of an automated guided vehicle.

Navigation modules employing lasers for determining the position of vehicles, for example automated guided vehicles (AGVs), are known.

Such navigation modules include a light source, such as a laser emitter, for emitting light and a detector or receiver for detecting or receiving light that is reflected by one or more target objects. The target objects may include reflective objects, such as small mirrors, placed in predetermined places, for example shelving in a warehouse for AGV navigation. The navigation module moves with the AGV. The navigation module may also move relative to the AGV, e.g. the navigation module may spin.

The navigation module emits light continuously in order to detect the edges of a target object. As long as the edges correspond to an object of a predetermined size, then the navigation module determines that the object is a relevant or predetermined target.

In a controlled environment, such as a warehouse, the position of an AGV can be determined accurately using such navigation modules and reflective targets. Since the reflective targets are of a particular size and/or shape, the reflective targets can be distinguished from random reflective objects within the environment. The navigation module only needs to identify multiple targets in order to determine (e.g. triangulate) its location within the environment. The environment does, however, need to be surveyed (each and every mirror needs to be located with very high accuracy), which is time consuming and expensive.

It would therefore be advantageous to provide a navigation module which overcomes the limitations of prior art navigation modules. In particular, it would be advantageous to provide a more versatile navigation module.

### SUMMARY

A broad aspect of the invention provides a navigation module, e.g. for determining the position of an automated guided vehicle, the navigation module being operable to identify a predetermined artefact and to determine a distance to the predetermined artefact.

The navigation module may comprise a light source for emitting light. The navigation module may comprise a receiver or detector for receiving light emitted from the light source. The navigation module may comprise a processor. The processor may be operatively connected to the light source and/or to the receiver or detector.

The navigation module may comprise a first mode of operation, e.g. in which light is emitted substantially continuously from the light source. The processor may process light received by the receiver or detector in the first mode of operation to identify the predetermined artefact.

The navigation module may comprise a second mode of operation, e.g. in which light is pulsed from the light source. The processor may process light received by the receiver or detector in the second mode of operation to determine the distance to the predetermined artefact.

The predetermined artefact may comprise a predetermined reflective target.

Another aspect of the invention provides a navigation module for determining the position of an automated guided vehicle, the navigation module comprising: a light source for emitting light; a receiver or detector for receiving light emitted from the light source; and a processor operatively connected to the light source and to the receiver; wherein the navigation module comprises: a first mode of operation in which light is emitted substantially continuously from the light source and the processor processes light received by the receiver to identify a predetermined reflective target; and a second mode of operation in which light is pulsed from the light source and the processor processes light received by the receiver to determine a distance to the predetermined reflective target.

Distance measurement is not required in conventional automated guided vehicle environments. The applicant has recognised that the provision of distance measurement enables the automated guided vehicle to navigate more accurately based on a less accurate digital representation of the environment. Advantageously, this obviates the need for a formal survey, which is time consuming and expensive.

The light source may include a first emitter. The first emitter may be a first laser, for example a continuous wave laser or a constant wave laser. The first emitter may be configured to operate in the first mode of operation. The light source may include a second emitter. The second emitter may be a second laser, for example a pulsed laser. The second emitter may be configured to operate in the second mode of operation.

The light source may be configured to operate in the first mode of operation and the second mode of operation sequentially (i.e. the light source may be operated in the first mode of operation to locate a predetermined reflective target and subsequently in the second mode of operation to determine the distance between the navigation module and the predetermined reflective target). The processor may be configured to switch the navigation module between the first mode of operation and the second mode of operation. The processor may be configured to switch the light source between the first emitter and the second emitter.

The light source may be configured to operate in the first mode of operation and the second mode of operation simultaneously (i.e. the light source may be operated in the first mode of operation and the second mode of operation at the same time).

The receiver or detector may comprise a first light sensor or photodetector. The first light sensor or photodetector may be configured to receive light emitted, in use, by the first emitter. The receiver may comprise a second light sensor or photodetector. The second light sensor or photodetector may be configured to receive light emitted, in use, by the second emitter.

The first emitter may be configured to emit light having a first wavelength. The second emitter may be configured to emit light having a second wavelength.

The first emitter may be configured to emit light having a first colour. The second emitter may be configured to emit light having a second colour.

The first emitter may be spaced apart from the second emitter. The first emitter and the second emitter may be physically offset relative to each other. The first emitter and the second emitter may, for example, be mounted side by side. The first emitter may be mounted at an angle, for example a non-zero angle, relative to the second emitter. The angle defined between the first emitter and the second emitter may be less than 90 degrees, for example less than 45 degrees, preferably less than 30 degrees. The angle defined between the first emitter and the second emitter may be greater than 5 degrees, for example greater than 10 degrees, preferably greater than 15 degrees. The angle defined between the first emitter and the second emitter may be approximately 20 degrees.

When the light source includes a first emitter and a second emitter, a receiver or detector including a first light sensor and a second light sensor may be provided. In such embodiments of the invention, the light emitted from the first emitter and the light emitted from the second light emitter may have the same, or similar, wavelengths. Similarly, in such embodiments of the invention, the light emitted from the first emitter and the light emitted from the second emitter may have the same, or similar, colours.

The receiver or detector may comprise a single light sensor or photodetector. The single light sensor or photodetector may be configured to receive light emitted, in use, by the first emitter. The single light sensor or photodetector may be configured to receive light emitted, in use, by the second emitter.

The provision of a first emitter which is configured to emit light having a first wavelength and a second emitter which is configured to emit light having a second wavelength enables the use of a receiver or detector having a single light sensor.

Similarly, the provision of a first emitter which is configured to emit light having a first colour and a second emitter which is configured to emit light having a second colour enables the use of a receiver or detector having a single light sensor.

The use of a first emitter which is configured to emit light having a first wavelength and a second emitter which is configured to emit light having a second wavelength also enables the use of a receiver or detector having a first light sensor and a second light sensor, wherein the first light sensor and the second light sensor are adjacent or in close proximity.

Similarly, the use of a first emitter which is configured to emit light having a first colour and a second emitter which is configured to emit light having a second colour also enables the use of a receiver or detector having a first light sensor and a second light sensor, wherein the first light sensor and the second light sensor are adjacent or in close proximity.

The light source may include a single emitter. The light source may include a single laser. The single emitter may be configured to operate in the first mode of operation. The single emitter may also be configured to operate in the second mode of operation. The light source may be configured to operate in the first mode of operation and the second mode of operation sequentially (i.e. the light source may be operated in the first mode of operation and subsequently in the second mode of operation). The processor may be configured to switch the single emitter between the first mode of operation and the second mode of operation.

The navigation module may be configured to rotate or spin. The navigation module may comprise a rotation stage. The rotation stage may be configured to rotate or spin the navigation module.

The predetermined reflective target may include a mirror. The predetermined reflective target may have a predetermined shape. The predetermined reflective target may have a predetermined size, for example a predetermined length and/or a predetermined width. The predetermined reflective target may include a retroreflector. The predetermined reflective target may include a retroreflective target attached to an object. Advantageously, the retroreflector or the retroreflective target reflects the light back to the navigation module without increasing the divergence of the light, thereby maximising the intensity of the light reflected back to the navigation module. This may help distinguish light reflected from the predetermined reflective target from light reflected by other objects, e.g. shiny, non-target, objects within an environment. The navigation module may be configured to measure a dimension of the reflective object in order to distinguish light reflected by shiny, non-target, objects and light reflected by predetermined reflective targets.

In the first mode of operation, the navigation module may be operable to detect one or more, for example two or more, edges of the predetermined reflective target. In the first mode of operation, the navigation module may be operable to detect at least a portion of the periphery or outer edge or perimeter of the predetermined reflective target. The predetermined reflective target may have a width and a length or a height. In the first mode of operation, the navigation module may be operable to detect at least a portion of the width. In the first mode of operation, the navigation module may be operable to detect at least a portion of the length or the height of the predetermined reflective target. In the first mode of operation, the processor may be operable to determine or identify a predetermined reflective target by processing light reflected by a reflective object. In the first mode of operation, the navigation module may be operable to determine or measure a dimension, for example the width, the length or the height, of an object in order to distinguish shiny, non-target, objects from predetermined reflective targets.

In the second mode of operation, a single pulse of light may be emitted from the light source. In the second mode of operation, the light source may be operable to emit a single pulse of light. A single pulse of light may be emitted from the light source after the processor has identified a predetermined reflective target. In the second mode of operation, the processor may be operable to determine a distance between the navigation module and the predetermined reflective target by determining the time of flight between emission and detection of the single pulse of light.

In the second mode of operation, multiple pulses of light may be emitted from the light source. In the second mode of operation, the light source may be operable to emit multiple pulses of light. Multiple pulses of light may be emitted from the light source after the processor has identified or determined the presence of a predetermined reflective target. In the second mode of operation, the light source may be operable to emit multiple pulses of light intermittently or sporadically. The emission of pulses of light from the light source may be irregular in the second mode of operation. In the second mode of operation, the light source may be operable to emit multiple pulses of light regularly. In the second mode of operation, the processor may be operable to determine a distance between the navigation module and the predetermined reflective target by determining the time of flight between emission and detection of multiple pulses of light.

According to another aspect of the invention there is provided an automated guided vehicle including a navigation module according to the previous aspects of the invention.

The navigation module may be configured to move with the AGV. The navigation module may be configured to move relative to the AGV. The navigation module may, for example, be configured to rotate or revolve or spin relative to the AGV. The navigation module may comprise a rotation stage. The rotation stage may be configured to rotate or spin the navigation module.

In some embodiments of the invention, the first mode of operation may be turned on or triggered. The navigation module may spin and detect a predetermined reflective target, for example during a first revolution of the navigation module. The navigation module may spin one or more additional times in order to measure a dimension, for example a width, of the predetermined reflective target. The navigation module may switch from the first mode of operation to the second mode of operation. Alternatively, the second mode of operation may be turned on or triggered. The navigation module may spin and measure the distance to the predetermined reflective target during a subsequent revolution of the navigation module.

The navigation module may be able to detect multiple predetermined reflective targets almost simultaneously during the first revolution or spin. The distance to each of the predetermined reflective targets may be measured in the second or subsequent revolution or spin.

A further aspect of the invention provides an automated guided vehicle navigation system for determining the position of an automated guided vehicle, the automated guided vehicle navigation system comprising: a navigation module comprising: a light source for emitting light; a receiver or detector for receiving light emitted from the light source; and a processor operatively connected to the light source and to the receiver; wherein the automated guided vehicle navigation system further comprises a predetermined reflective target; and wherein the navigation module further comprises: a first mode of operation in which light is emitted substantially continuously from the light source and the processor processes light received by the receiver to identify the predetermined reflective target; and a second mode of operation in which light is pulsed from the light source and the processor processes light received by the receiver to determine a distance to the predetermined reflective target.

Distance measurement is not required in conventional AGV environments. The applicant has recognised that the provision of distance measurement enables the AGV to navigate more accurately based on a less accurate digital representation of the environment. Advantageously, this obviates the need for a formal survey, which is time consuming and expensive.

The predetermined reflective target may be a mirror. The predetermined reflective target may have a predetermined shape. The predetermined reflective target may have a predetermined size, for example a predetermined length and/or a predetermined width. The predetermined reflective target may include a retroreflector. The predetermined reflective target may include a retroreflective target attached to an object. Advantageously, the retroreflector or the retroreflective target reflects the light back to the navigation module without increasing the divergence of the light, thereby maximising the intensity of the light reflected back to the navigation module. This may help distinguish light reflected from the predetermined reflective target from light reflected by other objects, e.g. shiny, non-target, objects within an environment. The navigation module may be configured to measure a dimension of the reflective object in order to distinguish light reflected by shiny, non-target, objects and light reflected by predetermined reflective targets.

The light source may comprise a first emitter. The first emitter may be a first laser, e.g. a continuous wave laser or a constant wave laser. The first emitter may be configured to operate in the first mode of operation. The light source may comprise a second emitter. The second emitter may be a second laser, e.g. a pulsed laser. The second emitter may be configured to operate in the second mode of operation.

The light source may be configured to operate in the first mode of operation and the second mode of operation sequentially (i.e. the light source may be operated in the first mode of operation to locate a predetermined reflective target and subsequently in the second mode of operation to determine the distance between the navigation module and the predetermined reflective target). The processor may be configured to switch the navigation module between the first mode of operation and the second mode of operation. The processor may be configured to switch the light source between the first emitter and the second emitter.

The light source may be configured to operate in the first mode of operation and the second mode of operation simultaneously (i.e. the light source may be operated in the first mode of operation and the second mode of operation at the same time). The processor may be configured to switch the light source between the first mode of operation and the second mode of operation.

The receiver or detector may comprise a first light sensor or photodetector. The first light sensor or photodetector may be configured to receive light emitted, in use, by the first emitter. The receiver may comprise a second light sensor or photodetector. The second light sensor or photodetector may be configured to receive light emitted, in use, by the second emitter.

The first emitter may be configured to emit light having a first wavelength. The second emitter may be configured to emit light having a second wavelength.

The first emitter may be configured to emit light having a first colour. The second emitter may be configured to emit light having a second colour.

The first emitter may be spaced apart from the second emitter. The first emitter and the second emitter may be physically offset relative to each other. The first emitter and the second emitter may, for example, be mounted side by side. The first emitter may be mounted at an angle, for example a non-zero angle, relative to the second emitter. The angle defined between the first emitter and the second emitter may be less than 90 degrees, for example less than 45 degrees, preferably less than 30 degrees. The angle defined between the first emitter and the second emitter may be greater than 5 degrees, for example greater than 10 degrees, preferably greater than 15 degrees. The angle defined between the first emitter and the second emitter may be approximately 20 degrees.

When the light source includes a first emitter and a second emitter, a receiver or detector including a first light sensor and a second light sensor may be provided. In such embodiments of the invention, the light emitted from the first emitter and the light emitted from the second light emitter may have the same, or similar, wavelengths. Similarly, in such embodiments of the invention, the light emitted from the first emitter and the light emitted from the second emitter may have the same, or similar, colours.

The receiver or detector may comprise a single light sensor or photodetector. The single light sensor or photodetector may be configured to receive light emitted, in use, by the first emitter. The single light sensor or photodetector may be configured to receive light emitted, in use, by the second emitter.

The provision of a first emitter which is configured to emit light having a first wavelength and a second emitter which is configured to emit light having a second wavelength enables the use of a receiver or detector having a single light sensor.

Similarly, the provision of a first emitter which is configured to emit light having a first colour and a second emitter which is configured to emit light having a second colour enables the use of a receiver or detector having a single light sensor.

The use of a first emitter which is configured to emit light having a first wavelength and a second emitter which is configured to emit light having a second wavelength also enables the use of a receiver or detector having a first light sensor and a second light sensor, wherein the first light sensor and the second light sensor are adjacent or in close proximity.

Similarly, the use of a first emitter which is configured to emit light having a first colour and a second emitter which is configured to emit light having a second colour also enables the use of a receiver or detector having a first light sensor and a second light sensor, wherein the first light sensor and the second light sensor are adjacent or in close proximity.

The light source may include a single emitter. The light source may include a single laser. The single emitter may also be configured to operate in the first mode of operation. The single emitter may be configured to operate in the second mode of operation. The light source may be configured to operate in the first mode of operation and the second mode of operation sequentially (i.e. the light source may be operated in the first mode of operation and subsequently in the second mode of operation). The processor may be configured to switch the single emitter between the first mode of operation and the second mode of operation.

The navigation module may be configured to rotate or spin. The navigation module may include a rotation stage. The rotation stage may be configured to rotate or spin the navigation module.

The predetermined reflective target may include a mirror. The predetermined reflective target may have a predetermined shape. The predetermined reflective target may have a predetermined size, for example a predetermined length and/or a predetermined width. The predetermined reflective target may include a retroreflector. The predetermined reflective target may include a retroreflective target attached to an object. Advantageously, the retroreflector or the retroreflective target reflects the light back to the navigation module without increasing the divergence of the light, thereby maximising the intensity of the light reflected back to the navigation module. This may help distinguish light reflected from the predetermined reflective target from light reflected by other objects, e.g. shiny, non-target, objects within an environment. The navigation module may be configured to measure a dimension of the reflective object in order to distinguish light reflected by shiny, non-target, objects and light reflected by predetermined reflective targets.

In the first mode of operation, the navigation module may be operable to detect one or more, for example two or more, edges of the predetermined reflective target. In the first mode of operation, the navigation module may be operable to detect at least a portion of the periphery or outer edge or perimeter of the predetermined reflective target. The predetermined reflective target may have a width and a length or a height. In the first mode of operation, the navigation module may be operable to detect at least a portion of the width. In the first mode of operation, the navigation module may be operable to detect at least a portion of the length or the height of the predetermined reflective target. In the first mode of operation, the processor may be operable to determine or identify a predetermined reflective target by processing light reflected by a reflective object. In the first mode of operation, the navigation module may be operable to determine or measure a dimension, for example the width, the length or the height, of an object in order to distinguish shiny, non-target, objects from predetermined reflective targets.

In the second mode of operation, a single pulse of light may be emitted from the light source. In the second mode of operation, the light source may be operable to emit a single pulse of light. A single pulse of light may be emitted from the light source after the processor has identified a predetermined reflective target. In the second mode of operation, the processor may be operable to determine a distance between the navigation module and the predetermined reflective target by determining the time of flight between emission and detection of the single pulse of light.

In the second mode of operation, multiple pulses of light may be emitted from the light source. In the second mode of operation, the light source may be operable to emit multiple pulses of light. Multiple pulses of light may be emitted from the light source after the processor has identified or determined the presence of a predetermined reflective target. In the second mode of operation, the light source may be operable to emit multiple pulses of light intermittently or sporadically. The emission of pulses of light from the light source may be irregular in the second mode of operation. In the second mode of operation, the light source may be operable to emit multiple pulses of light regularly. In the second mode of operation, the processor may be operable to determine a distance between the navigation module and the predetermined reflective target by determining the time of flight between emission and detection of multiple pulses of light.

A yet further aspect of the invention provides a method of determining the position of an automated guided vehicle, the method comprising: providing a navigation module comprising: a light source for emitting light; a receiver or detector for receiving light emitted from the light source; and a processor operatively connected to the light source and to the receiver; operating the navigation module in a first mode of operation in which light is emitted substantially continuously from the light source, the receiver receives light emitted from the light source, and the processor processes light received by the receiver to identify a predetermined reflective target; and operating the navigation module in a second mode of operation in which light is pulsed from the light source, the receiver receives light emitted from the light source, and the processor processes light received by the receiver to determine a distance to the predetermined reflective target.

Distance measurement is not required in conventional AGV environments. The applicant has recognised that the provision of distance measurement enables the AGV to navigate more accurately based on a less accurate digital representation of the environment. Advantageously, this obviates the need for a formal survey, which is time consuming and expensive.

The steps of operating the navigation module in the first mode of operation and operating the navigation module in the second mode of operation may be performed substantially simultaneously. In other words, the light source may be operated in the first mode of operation and the second mode of operation at the same time.

Alternatively, the step of operating the navigation module in the first mode of operation may be performed before the step of operating the navigation module in the second mode of operation. In other words, the light source may be operated in the first mode of operation and subsequently in the second mode of operation.

The predetermined reflective target may be a mirror. The predetermined reflective target may have a predetermined shape. The predetermined reflective target may have a predetermined size, e.g. a predetermined length and/or a predetermined width. The predetermined reflective target may include a retroreflector. The predetermined reflective target may include a retroreflective target attached to an object. Advantageously, the retroreflector or the retroreflective target reflects the light back to the navigation module without increasing the divergence of the light, thereby maximising the intensity of the light reflected back to the navigation module. This may help distinguish light reflected from the predetermined reflective target from light reflected by other objects, e.g. shiny, non-target, objects within an environment. The navigation module may be configured to measure a dimension of the reflective object in order to distinguish light reflected by shiny, non-target, objects and light reflected by predetermined reflective targets.

The light source may comprise a first emitter. The first emitter may be a first laser, e.g. a continuous wave laser or a constant wave laser. The first emitter may be configured to operate in the first mode of operation. In the first mode of operation, the first emitter may be operated to emit light substantially continuously. The light source may comprise a second emitter. The second emitter may be a second laser, e.g. a pulsed laser. The second emitter may be configured to operate in the second mode of operation. In the second mode of operation, the second emitter may be operated to pulse light. The processor may be configured to switch the light source between the first mode of operation and the second mode of operation.

The receiver or detector may comprise a first light sensor or photodetector. The first light sensor or photodetector may be configured to receive light emitted, in use, by the first emitter. The receiver or detector may comprise a second light sensor or photodetector. The second light sensor or photodetector may be configured to receive light emitted, in use, by the second emitter.

The first emitter may be operated to emit light having a first wavelength. The second emitter may be operated to emit light having a second wavelength.

The first emitter may be configured to emit light having a first colour. The second emitter may be configured to emit light having a second colour.

The first emitter may be spaced apart from the second emitter. The first emitter and the second emitter may be physically offset relative to each other. The first emitter and the second emitter may, for example, be mounted side by side. The first emitter may be mounted at an angle, for example a non-zero angle, relative to the second emitter. The angle defined between the first emitter and the second emitter may be less than 90 degrees, for example less than 45 degrees, preferably less than 30 degrees. The angle defined between the first emitter and the second emitter may be greater than 5 degrees, for example greater than 10 degrees, preferably greater than 15 degrees. The angle defined between the first emitter and the second emitter may be approximately 20 degrees.

When the light source includes a first emitter and a second emitter, a receiver or detector including a first light sensor and a second light sensor may be provided. In such embodiments of the invention, the light emitted from the first emitter and the light emitted from the second light emitter may have the same, or similar, wavelengths. Similarly, in such embodiments of the invention, the light emitted from the first emitter and the light emitted from the second emitter may have the same, or similar, colours.

The receiver or detector may include a single light sensor or photodetector. The single light sensor or photodetector may be configured to receive light emitted, in use, by the first emitter. The single light sensor or photodetector may be configured to receive light emitted, in use, by the second emitter.

The provision of a first emitter which is configured to emit light having a first wavelength and a second emitter which is configured to emit light having a second wavelength enables the use of a receiver or detector having a first light sensor and a second light sensor which are adjacent or in close proximity.

Similarly, the use of a first emitter which is configured to emit light having a first colour and a second emitter which is configured to emit light having a second colour also enables the use of a receiver or detector having a first light sensor and a second light sensor, wherein the first light sensor and the second light sensor are adjacent or in close proximity.

The use of a first emitter which is configured to emit light having a first wavelength and a second emitter which is configured to emit light having a second wavelength also enables the use of a receiver or detector having a single light sensor.

Similarly, the provision of a first emitter which is configured to emit light having a first colour and a second emitter which is configured to emit light having a second colour enables the use of a receiver or detector having a single light sensor.

The light source may include a single emitter. The light source may include a single laser. The single emitter may be configured to operate in the first mode of operation. In the first mode of operation, the first emitter may be operated to emit light substantially continuously. The single emitter may also be configured to operate in the second mode of operation. In the second mode of operation, the first emitter may be operated to pulse light. The processor may be configured to switch the single emitter between the first mode of operation and the second mode of operation.

The navigation module may be configured to rotate or spin. The navigation module may comprise a rotation stage. The rotation stage may be configured to rotate or spin the navigation module.

In the first mode of operation, the navigation module may be operable to detect one or more, for example two or more, edges of the predetermined reflective target. In the first mode of operation, the navigation module may be operable to detect at least a portion of the periphery or outer edge or perimeter of the predetermined reflective target. The predetermined reflective target may have a width and a length or a height. In the first mode of operation, the navigation module may be operable to detect at least a portion of the width. In the first mode of operation, the navigation module may be operable to detect at least a portion of the length or the height of the predetermined reflective target. In the first mode of operation, the processor may be operable to determine or identify a predetermined reflective target by processing light reflected by a reflective object. In the first mode of operation, the navigation module may be operable to determine or measure a dimension, for example the width, the length or the height, of an object in order to distinguish shiny, non-target, objects from predetermined reflective targets.

In the second mode of operation, a single pulse of light may be emitted from the light source. In the second mode of operation, the light source may be operable to emit a single pulse of light. A single pulse of light may be emitted from the light source after the processor has identified a predetermined reflective target. In the second mode of operation, the processor may be operable to determine a distance between the navigation module and the predetermined reflective target by determining the time of flight between emission and detection of the single pulse of light.

In the second mode of operation, multiple pulses of light may be emitted from the light source. In the second mode of operation, the light source may be operable to emit multiple pulses of light. Multiple pulses of light may be emitted from the light source after the processor has identified or determined the presence of a predetermined reflective target. In the second mode of operation, the light source may be operable to emit multiple pulses of light intermittently or sporadically. The emission of pulses of light from the light source may be irregular in the second mode of operation. In the second mode of operation, the light source may be operable to emit multiple pulses of light regularly. In the second mode of operation, the processor may be operable to determine a distance between the navigation module and the predetermined reflective target by determining the time of flight between emission and detection of multiple pulses of light.

A further aspect of the invention provides a method of improving a digital representation of an operating environment for an automated guided vehicle, the method comprising: determining the position of at least one predetermined reflective target within the operating environment using a navigation module; and updating the digital representation of the operating environment with the determined position.

The digital representation of the operating environment may include an expected position for the at least one predetermined reflective target.

The operating environment may be a warehouse.

The navigation module may comprise a light source for emitting light. The navigation module may comprise a receiver or detector for receiving light emitted from the light source.

The navigation module may comprise a processor operatively connected to the light course and to the receiver or detector.

The step of determining the position of the at least one predetermined reflective target within the operating environment may comprise operating the navigation module in a first mode of operation in which light is emitted substantially continuously from the light source, the receiver receives light emitted from the light source, and the processor processes light received by the receiver to identify the at least one predetermined reflective target. The step of determining the position of the at least one predetermined reflective target may further comprise determining or measuring a dimension, for example a width, of an object in order to distinguish light reflected by shiny, non-target, objects and light reflected by the at least one predetermined reflective target.

The step of determining the position of the at least one predetermined reflective target within the operating environment may further comprise operating the navigation module in a second mode of operation in which light is pulsed from the light source, the receiver receives light emitted from the light source, and the processor processes light received by the receiver to determine a distance between the at least one predetermined reflective target and the navigation module.

The step of determining the position of the at least one predetermined reflective target within the operating environment may comprise processing information relating to the identity of the at least one predetermined reflective target and the distance between the at least one predetermined reflective target and the navigation module to determine the position of the at least one predetermined reflective target.

The method may further comprise comparing the determined position of the at least one predetermined reflective target with the expected position of the at least one predetermined reflective target.

For the avoidance of doubt, any of the features described herein apply equally to any aspect of the invention. For example, the navigation module may comprise any one or more features of the automated guided vehicle navigation system relevant to the navigation module and/or the method may comprise any one or more features or steps relevant to one or more features of the navigation module or the automated guided vehicle navigation system.

A further aspect of the invention provides a computer program element comprising computer readable program code means for causing a processor to execute a procedure to implement one or more steps of the aforementioned method.

A yet further aspect of the invention provides the computer program element embodied on a computer readable medium.

A yet further aspect of the invention provides a computer readable medium having a program stored thereon, where the program is arranged to make a computer execute a procedure to implement one or more steps of the aforementioned method.

A yet further aspect of the invention provides a control means or control system or controller comprising the aforementioned computer program element or computer readable medium.

For purposes of this disclosure, and notwithstanding the above, it is to be understood that any controller(s), control units and/or control modules described herein may each comprise a control unit or computational device having one or more electronic processors. The controller may comprise a single control unit or electronic controller or alternatively different functions of the control of the system or apparatus may be embodied in, or hosted in, different control units or controllers or control modules. As used herein, the terms “control unit” and “controller” will be understood to include both a single control unit or controller and a plurality of control units or controllers collectively operating to provide the required control functionality. A set of instructions could be provided which, when executed, cause said controller(s) or control unit(s) or control module(s) to implement the control techniques described herein (including the method(s) described herein). The set of instructions may be embedded in one or more electronic processors, or alternatively, may be provided as software to be executed by one or more electronic processor(s).

For example, a first controller may be implemented in software run on one or more electronic processors, and one or more other controllers may also be implemented in software run on or more electronic processors, optionally the same one or more processors as the first controller. It will be appreciated, however, that other arrangements are also useful, and therefore, the present invention is not intended to be limited to any particular arrangement. In any event, the set of instructions described herein may be embedded in a computer-readable storage medium (e.g., a non-transitory storage medium) that may comprise any mechanism for storing information in a form readable by a machine or electronic processors/computational device, including, without limitation: a magnetic storage medium (e.g., floppy diskette); optical storage medium (e.g., CD-ROM); magneto optical storage medium; read only memory (ROM); random access memory (RAM); erasable programmable memory (e.g., EPROM ad EEPROM); flash memory; or electrical or other types of medium for storing such information/instructions.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. For the avoidance of doubt, the terms “may”, “and/or”, “e.g.”, “for example” and any similar term as used herein should be interpreted as non-limiting such that any feature so-described need not be present. Indeed, any combination of optional features is expressly envisaged without departing from the scope of the invention, whether or not these are expressly claimed. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

Embodiments of the invention will now be described by way of example only with reference to the accompanying drawings in which:

FIG. 1 is a schematic representation of a navigation module according to an embodiment of the invention;

FIG. 2 is a schematic plan view of an automated guided vehicle including the navigation module of FIG. 1 in a transport area;

FIG. 3 is a flow diagram showing the steps in the operation of the navigation module of FIG. 1;

FIG. 4 is a schematic representation of a navigation module according to an alternative embodiment of the invention; and

FIG. 5 is a schematic representation of a navigation module according to a further embodiment of the invention.

### DETAILED DESCRIPTION

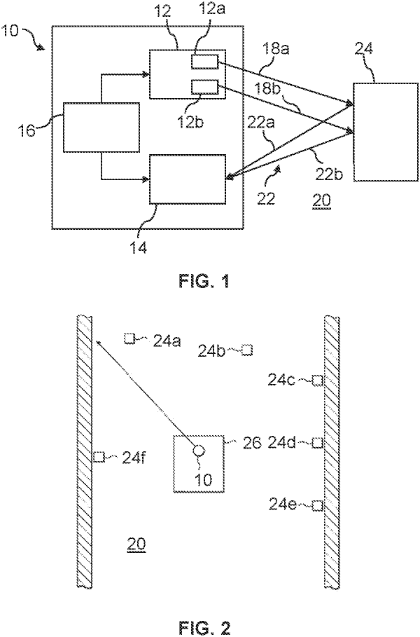

Referring now to FIG. 1, there is shown a navigation module 10 according to an embodiment of the invention.

The navigation module 10 comprises a light source 12, a receiver 14 and a processor 16.

The light source 12 includes a first emitter 12a, for example a first, continuous wave, laser, and a second emitter 12b, for example a second, pulsed, laser. The first emitter 12a is configured to emit a first beam of light 18a over a search sector 20, for example within a warehouse. The first beam of light 18a has a first wavelength. The first beam of light 18a is a substantially continuous beam of light. The second emitter 12b is configured to emit a pulse of light 18b over the search sector 20. The pulse of light 18b has a second wavelength, which is different to the first wavelength. The pulse of light 18b may be a single pulse or may be multiple pulses of light. In embodiments of the invention where the pulse of light 18b is multiple pulses of light, the multiple pulses may be intermittent or the light may be pulsed regularly.

The receiver 14 is configured to receive or detect light 22 which is reflected by reflecting objects, such as a predetermined reflective target 24, in the search sector 20. The reflected light 22 includes a first beam of reflected light 22a and at least one pulse of reflected light 22b which are reflected by the predetermined reflective target 24. The first beam of reflected light 22a is a substantially continuous beam of light from the first emitter 12a which is reflected by the predetermined reflective target 24. The at least one pulse of reflected light 22b is pulsed from the second emitter 12b and reflected by the predetermined reflective target 24.

The processor 16 is operatively connected to the light source 12 and to the receiver 14.

The processor 16 is configured to control the light source 12 to operate in a first mode of operation and a second mode of operation, as will be described further below.

With reference to FIG. 2, an automated guided vehicle (AGV) 26 within a search area 20 is shown. The AGV 26 is equipped with a navigation module 10. The navigation module 10 includes a rotation stage (not shown) such that the navigation module 10 can move with the AGV 26 and can also revolve, spin or rotate relative to the AGV 26.

The search area 20 includes a number of reflective targets 24a, 24b, 24c, 24d, 24e, 24f which are in known locations. A digital representation, for example a map, of the search area 20 is made available to the navigation module 10 so that a comparison between scanned reflective targets and the map can be made in order to accurately determine the position of the AGV 26. More accurate identification of objects or reflective targets, as well as more accurate determination of the distance to an object or reflective target from the AGV, reduces the uncertainty when matching scanned reflective object positions to the map, thereby reducing the computational requirements of the navigation module 10. Such maps can also be produced and/or improved using an AGV 26 having a navigation module 10 according to the invention.

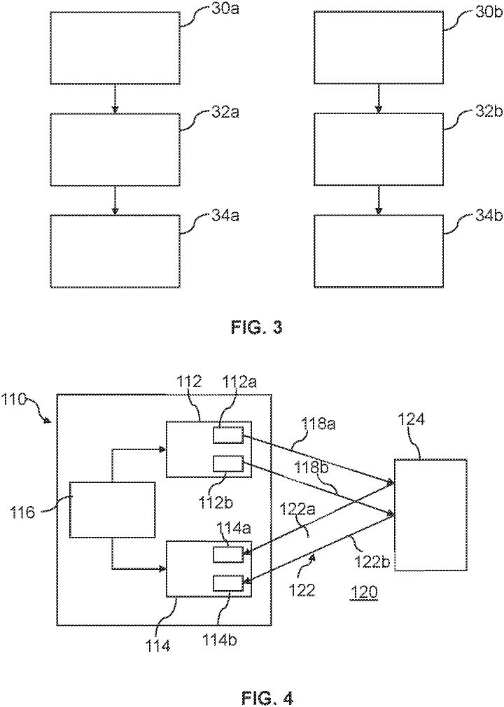

Operation of the navigation module 10 will now be described with particular reference to FIG. 3.

The AGV 26 is positioned within the search area 20. In order to locate the reflective targets 24a, 24b, 24c, 24d, 24e, 24f, the navigation module 10 is operated in the first mode of operation (steps 30a, 32a, 34a).

The rotation stage (not shown) is rotated in order to spin the navigation module 10 relative to the AGV 26.

In step 30a, the processor 16 controls the first emitter 12a of the light source 12 to emit a substantially continuous beam of light 18a within the search sector 20. As the navigation module 10 is rotated around the search area 20, the beam of light 18a is scanned across the surface of the reflective targets 24a, 24b, 24c, 24d, 24e, 24f. Light which is reflected by the reflective targets 24a, 24b, 24c, 24d, 24e, 24f is reflected back as the beam of reflected light 22a.

The reflected signals 22a from the reflective targets 24a, 24b, 24c, 24d, 24e, 24f, or other reflecting objects within the search sector 20, are detected or received by the receiver 14 (step 32a). The processor 16 processes the received beam of reflected light 22a and is thereby able to identify one or more, for example two or more, edges of the reflective targets 24a, 24b, 24c, 24d, 24e, 24f. In this way, the periphery or outer perimeter of the reflective 24a, 24b, 24c, 24d, 24e, 24f can be determined.

The processor 16 then compares the reflected signals 22a with a map in order to accurately identify or determine the position of the predetermined reflective targets 24a, 24b, 24c, 24d, 24e, 24f (step 34a).

The processor 16 uses the reflected signals 22a to determine or measure a dimension of the reflective target, for example the width defined between two edges of the reflective target. By comparing the measured dimension of the reflective target with the expected dimension for a predetermined reflective target, the processor 16 is able to reject reflections from shiny, non-target, objects within the search sector 20.

Once the position of the predetermined reflective targets 24a, 24b, 24c, 24d, 24e, 24f is determined, the processor 16 switches the navigation module into the second mode of operation (steps 30b, 32b and 34b) in order to accurately determine the distance between the AGV 26 and the predetermined reflective targets 24a, 24b, 24c, 24d, 24e, 24f.

The rotation stage (not shown) is rotated in order to spin the navigation module 10 relative to the AGV 26.

In step 30b, the processor 16 controls the second emitter 12b of the light source 12 to emit pulses of light 18b within the search sector 20 as the navigation module 26 spins. As the navigation module 10 is rotated around the search area 20, the pulse of light 18b reaches the surface of the reflective targets 24a, 24b, 24c, 24d, 24e, 24f. Light which is reflected by the reflective targets 24a, 24b, 24c, 24d, 24e, 24f is reflected back as the pulse of reflected light 22b.

Reflected signals 22b from the reflective targets 24a, 24b, 24c, 24d, 24e, 24f, or other reflecting objects within the search sector 20, are detected or received by the receiver 14 (step 32b).

The processor 16 measures the time of flight of the or each pulse in order to determine the distance of the predetermined reflective targets 24a, 24b, 24c, 24d, 24e, 24f from the AGV 26 (step 34b).

A navigation module 110 according to an alternative embodiment of the invention will now be described with reference to FIG. 4.

The navigation module 110 comprises a light source 112, a receiver 114 and a processor 116.

The light source 112 includes a first emitter 112a, for example a first laser, and a second emitter 112b, for example a second laser. The first emitter 112a is configured to emit a first beam of light 118a over a search sector 120, for example within a warehouse. The first beam of light 118a has a first wavelength. The first beam of light 118a is substantially continuous. The second emitter 112b is configured to emit a pulse of light 118b over the search sector 120. The second beam of light 118b has a second wavelength, which is different to the first wavelength. The pulse of light 118b may be a single pulse of light or may be multiple pulses of light. In embodiments of the invention where the pulse of light 118b is multiple pulses of light, the multiple pulses may be intermittent or the light may be pulsed regularly.

The receiver 114 is configured to receive or detect light 122 which is reflected by reflecting objects, such as a predetermined reflective target 124, in the search sector 120. The receiver 114 includes a first light sensor 114a and a second light sensor 114b The reflected light 122 includes a first beam of reflected light 122a and at least one pulse of reflected light 122b which are reflected by the predetermined reflective target 124. The first light sensor 114a is configured to receive the first beam of reflected light 122a. Similarly, the second light sensor 114b is configured to receive the at least one pulse of reflected light 112b. The first beam of reflected light 122a is a substantially continuous beam of light from the first emitter 112a which is reflected by the predetermined reflective target 124. The at least one pulse of reflected light 122b is pulsed from the second emitter 112b and reflected by the predetermined reflective target 124.

The processor 116 is operatively connected to the light source 112 and to the receiver 114.

The processor 116 is configured to control the light source 112 to operate in a first mode of operation and a second mode of operation, as is described above in relation to the first embodiment of the present invention.

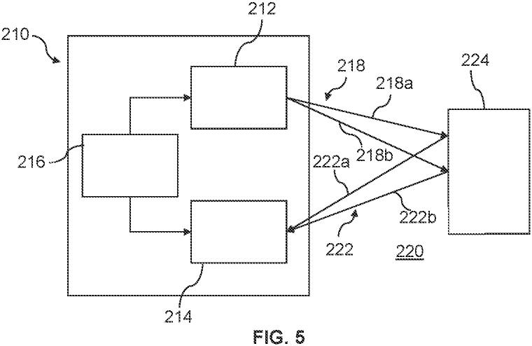

A navigation module 210 according to a further embodiment of the invention will now be described with reference to FIG. 5.

The navigation module 210 comprises a light source 212, a receiver 214 and a processor 216.

The light source 212 includes a single emitter, for example a single laser. The light source 212 is configured to emit a first beam of light 218a over a search sector 220, for example within a warehouse. The first beam of light 218a has a first wavelength. The first beam of light 218a is substantially continuous. The second emitter 212b is configured to emit a pulse of light 218b over the search sector 220. The second beam of light 218b has a second wavelength, which is different to the first wavelength. The pulse of light 218b may be a single pulse of light or may be multiple pulses of light. In embodiments of the invention where the pulse of light 218b is multiple pulses of light, the multiple pulses may be intermittent or the light may be pulsed regularly.

The receiver 214 is configured to receive or detect light 222 which is reflected by reflecting objects, such as a predetermined reflective target 224, in the search sector 220. The reflected light 222 includes a first beam of reflected light 222a and at least one pulse of reflected light 222b which are reflected by the predetermined reflective target 224. The first beam of reflected light 222a is a substantially continuous beam of light from the light source 212 which is reflected by the predetermined reflective target 224. The at least one pulse of reflected light 222b is pulsed from the light source 212 and reflected by the predetermined reflective target 224.

The processor 216 is operatively connected to the light source 212 and to the receiver 214.

The processor 216 is configured to control the light source 212 to operate in a first mode of operation and a second mode of operation, as is described above in relation to the first embodiment of the present invention.

The embodiment of FIG. 5 employs a single source (light source 212) to emit light in each of the modes of operation and a single detector (receiver 214) to receive reflected light in each of the modes of operation. The navigation module is operated in each mode of operation sequentially. The versatility of the invention is, therefore, provided by a less complex arrangement.

It will be appreciated by those skilled in the art that several variations to the aforementioned embodiments are envisaged without departing from the scope of the invention. For example, in the embodiments above, the first emitter 12a, 112a emits light 18a, 118a having a first wavelength and the second emitter 12b, 112b emits light 18b, 118b having a second wavelength which is different to the first wavelength. In alternative embodiments of the invention, the first and second emitters may be spaced apart, thereby removing the need for the first emitter and the second emitter to emit light having different wavelengths. The first emitter and the second emitter may, for example be physically offset relative to each other. The first emitter may be mounted at a non-zero angle, for example approximately 20 degrees, relative to the second emitter. By correlating the reflected light from each of the emitters in each of the modes of operation, light emitted from the first emitter and light emitted from the second emitter could have the same wavelength. Similarly, light emitted from the first emitter and light emitted from the second emitter could have the same colour.

In the embodiment described above, the light source 12 includes a first emitter 12a, which is configured to emit a first beam of light 18a which has a first wavelength. The light source 12 also includes a second emitter 12b, which is configured to emit a second beam of light 18b which has a second wavelength. The first and second wavelengths are different. In alternative embodiments of the invention, the first emitter may emit light having a first colour and the second emitter may emit light having a second colour. The first and second colours may be different.

In the embodiment described above, the light source 212 is configured to emit a first beam of light 218a which has a first wavelength. The light source is also configured to pulse a second beam of light 218b which has a second wavelength. The first and second wavelengths are different. In alternative embodiments of the invention, the light source may be configured to emit a first beam of light having a first colour and to pulse a second beam of light having a second colour, wherein the first and second colours may be different.

In the embodiment described above, steps 30a, 32a, 34a of the first mode of operation are carried out before steps 30b, 32b, 34b of the second mode of operation (i.e. the first mode of operation and the second mode of operation are performed sequentially). In alternative embodiments of the invention, steps 30a, 32a, 34a may be carried out at substantially the same time as steps 30b, 32b, 34b of the second mode of operation (i.e. the first and second modes of operation may be performed substantially simultaneously).

It will also be appreciated by those skilled in the art that any number of combinations of the aforementioned features and/or those shown in the appended drawings provide clear advantages over the prior art and are therefore within the scope of the invention described herein.

What is claimed is:

1. A navigation module for determining the position of an automated guided vehicle, the navigation module comprising:
a light source for emitting light;
a receiver for receiving light emitted from the light source; and
a processor operatively connected to the light source and to the receiver;
wherein the navigation module further comprises:
a first mode of operation in which light is emitted substantially continuously from the light source and the processor processes light received by the receiver to identify a predetermined reflective target; and
a second mode of operation in which light is pulsed from the light source and the processor processes light received by the receiver to determine a distance to the predetermined reflective target.

2. The navigation module according to claim 1, wherein the light source includes:
a first emitter which is configured to operate in the first mode of operation; and
a second emitter which is configured to operate in the second mode of operation.

3. The navigation module according to claim 2, wherein the receiver comprises:
a first light sensor which is configured to receive light emitted, in use, by the first emitter; and
a second light sensor which is configured to receive light emitted, in use, by the second emitter.

4. The navigation module according to claim 2, wherein
the first emitter is configured to emit light having a first wavelength; and
the second emitter is configured to emit light having a second wavelength.

5. The navigation module according to claim 2, wherein the first emitter is spaced apart from the second emitter, and/or wherein the receiver comprises a single light sensor which is configured to receive light emitted, in use, by the first emitter and light emitted, in use, by the second emitter.

6. An automated guided vehicle including the navigation module according to claim 1.

7. An automated guided vehicle navigation system for determining the position of an automated guided vehicle, the automated guided vehicle navigation system comprising:
a navigation module comprising:
a light source for emitting light;
a receiver for receiving light emitted from the light source; and
a processor operatively connected to the light source and to the receiver;
wherein the navigation system further comprises a predetermined reflective target; and
wherein the navigation module further comprises:
a first mode of operation in which light is emitted substantially continuously from the light source and the processor processes light received by the receiver to identify the predetermined reflective target; and
a second mode of operation in which light is pulsed from the light source and the processor processes light received by the receiver to determine a distance to the predetermined reflective target.

8. The automated guided vehicle navigation system according to claim 7, wherein the light source comprises:
a first emitter which is configured to operate in the first mode of operation; and
a second emitter which is configured to operate in the second mode of operation.

9. The automated guided vehicle navigation system according to claim 8, wherein the receiver comprises:
a first light sensor which is configured to receive light emitted, in use, by the first emitter; and
a second light sensor which is configured to receive light emitted, in use, by the second emitter.

10. The automated guided vehicle navigation system according to claim 8, wherein
the first emitter is configured to emit light having a first wavelength; and
the second emitter is configured to emit light having a second wavelength.

11. The automated guided vehicle navigation system according to claim 8, wherein the first emitter is spaced apart from the second emitter.

12. The automated guided vehicle navigation system according to claim 8, wherein the receiver comprises a single light sensor which is configured to receive light emitted, in use, by the first emitter and by the second emitter.

13. A method of determining the position of an automated guided vehicle, the method comprising:
providing a navigation module comprising:
a light source for emitting light;
a receiver for receiving light emitted from the light source; and
a processor operatively connected to the light source and to the receiver;
operating the navigation module in a first mode of operation in which light is emitted substantially continuously from the light source, the receiver receives light emitted from the light source, and the processor processes light received by the receiver to identify a predetermined reflective target; and
operating the navigation module in a second mode of operation in which light is pulsed from the light source, the receiver receives light emitted from the light source, and the processor processes light received by the receiver to determine a distance to the predetermined reflective target.

14. The method of determining the position of an automated guided vehicle according to claim 13, wherein the steps of operating the navigation module in the first mode of operation and operating the navigation module in the second mode of operation are performed substantially simultaneously.

15. The method of determining the position of an automated guided vehicle according to claim 13, wherein the step of operating the navigation module in the first mode of operation is performed before the step of operating the navigation module in the second mode of operation.

16. The method of determining the position of an automated guided vehicle according to claim 13, wherein the light source comprises:
a first emitter; and
a second emitter;
wherein, in the first mode of operation, the first emitter is operated to emit light substantially continuously; and
wherein, in the second mode of operation, the second emitter is operated to pulse light.

17. The method of determining the position of an automated guided vehicle according to claim 16, wherein the receiver comprises:
a first light sensor which receives light emitted, in use, by the first emitter; and
a second light sensor which receives light emitted, in use, by the second emitter.

18. The method of determining the position of an automated guided vehicle according to claim 16, wherein
the first emitter is operated to emit light having a first wavelength; and
the second emitter is operated to emit light having a second wavelength.

19. The method of determining the position of an automated guided vehicle according to claim 16, wherein the first emitter is spaced apart from the second emitter.

20. The method of determining the position of an automated guided vehicle according to claim 16, wherein the receiver includes a single light sensor which receives light emitted, in use, by the first emitter and light emitted, in use, by the second emitter.
